(19) United States
(12) Patent Application Publication
(10) Pub. No.: US 2024/0075545 A1
(43) Pub. Date: Mar. 7, 2024

(54) BLADE WITH CARBIDE TIPS

(71) Applicant: MILWAUKEE ELECTRIC TOOL CORPORATION, Brookfield, WI (US)

(72) Inventor: John J. Springer, Milwaukee, WI (US)

(21) Appl. No.: 18/461,091

(22) Filed: Sep. 5, 2023

Related U.S. Application Data
(60) Provisional application No. 63/403,953, filed on Sep. 6, 2022.

(51) Int. Cl. B23D 61/00

(52) U.S. Cl. CPC B23D 61/006

(57) ABSTRACT

A blade including a body having an untoothed distal edge. A plurality of recesses are recessed from distal ends of the distal edge. The blade also includes a plurality of carbide tips attached to the body to form a toothed portion configured to perform a cutting operation. Each of the carbide tips is received in a respective one of the recesses. Each of the carbide tips at least mostly fills the respective one of the recesses.

### CROSS-REFERENCE TO RELATED APPLICATION

This application claims priority to co-pending U.S. Provisional Patent Application No. 63/403,953, filed on Sep. 6, 2022, the entire contents of which are incorporated herein by reference.

### BACKGROUND

The present disclosure relates to a blade for cutting a workpiece and, more specifically, to a blade for power tools.

### SUMMARY

In one aspect, the disclosure provides a blade including a body having an untoothed distal edge. A plurality of recesses are recessed from distal ends of the distal edge. The blade also includes a plurality of carbide tips attached to the body to form a toothed portion configured to perform a cutting operation. Each of the carbide tips is received in a respective one of the recesses. Each of the carbide tips at least mostly fills the respective one of the recesses.

In another aspect, the disclosure provides a blade including a body, and a plurality of discrete carbide tips attached to the body to form a toothed portion configured to perform a cutting operation. The body is untoothed.

In yet another aspect, the disclosure provides an oscillating multi-tool blade. The oscillating multi tool blade includes an attachment portion configured to be driven in a rotational oscillating motion by an oscillating multi-tool, a body extending from the attachment portion, and a plurality of carbide tips attached to the body to form a toothed portion configured to perform a cutting operation. Each of the plurality of carbide tips is disposed discretely from the others.

Other aspects of the disclosure will become apparent by consideration of the detailed description and accompanying drawings.

### BRIEF DESCRIPTION OF THE DRAWINGS

FIG. 1 is a side view of a power tool for receiving interchangeable working tools, such as blades.

FIG. 2 is a side view cross-section of a portion of the power tool of FIG. 1.

FIG. 3 is a top view of a blade attachable to the power tool of FIG. 1 according to one implementation of the disclosure.

FIG. 4 is a side view of one implementation of the blade shown in FIG. 3.

FIG. 5 is an alternative side view illustrating an alternative implementation of the blade shown in FIG. 3.

FIG. 6 is a detail view of a toothed portion of the blade shown in FIG. 3.

FIG. 7 is an enlarged view of a portion of the toothed portion shown in FIG. 6, with three carbide tips not shown for illustration purposes.

FIG. 8 is an enlarged view of a portion of the toothed portion shown in FIG. 6.

FIG. 9A is an enlarged top view of one carbide tip of the toothed portion shown in FIG. 6.

FIG. 9B is an enlarged front elevation view of the one carbide tip shown in FIG. 9A.

FIG. 10 illustrates a cylindrical carbide blank from which the carbide tip shown in FIGS. 9A-9B may be formed.

FIG. 11 illustrates a reciprocating saw blade according to another implementation of the disclosure.

FIG. 12 illustrates a linear saw blade according to another implementation of the disclosure.

FIG. 13 illustrates a circular saw blade according to yet another implementation of the disclosure.

FIG. 14 illustrates a welding operation for the toothed portion shown in FIG. 6.

FIG. 15A is a perspective view of an alternative body for the blade shown in FIG. 3 with carbide tips according to another implementation.

FIG. 15B is a detail view of the carbide tips of FIG. 15A.

FIG. 16A is a cross-section view of a portion of the body shown in FIG. 15A with the carbide tips removed to illustrate recesses.

FIG. 16B is a detail front edge view of the portion of the body shown in FIG. 15B with the carbide tips removed to illustrate the recesses.

### DETAILED DESCRIPTION

Before any implementations of the disclosure are explained in detail, it is to be understood that the disclosure is not limited in its application to the details of construction and the arrangement of components set forth in the following description or illustrated in the following drawings. The disclosure is capable of other implementations and of being practiced or of being carried out in various ways.

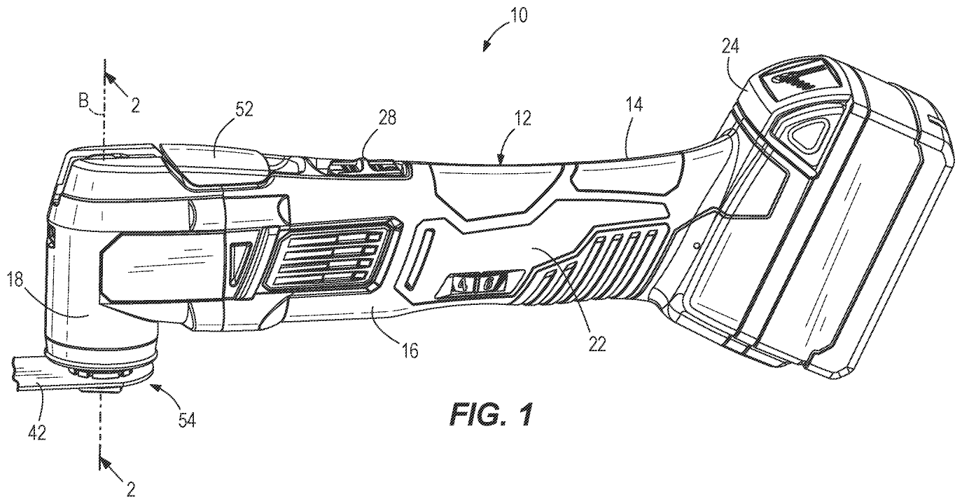

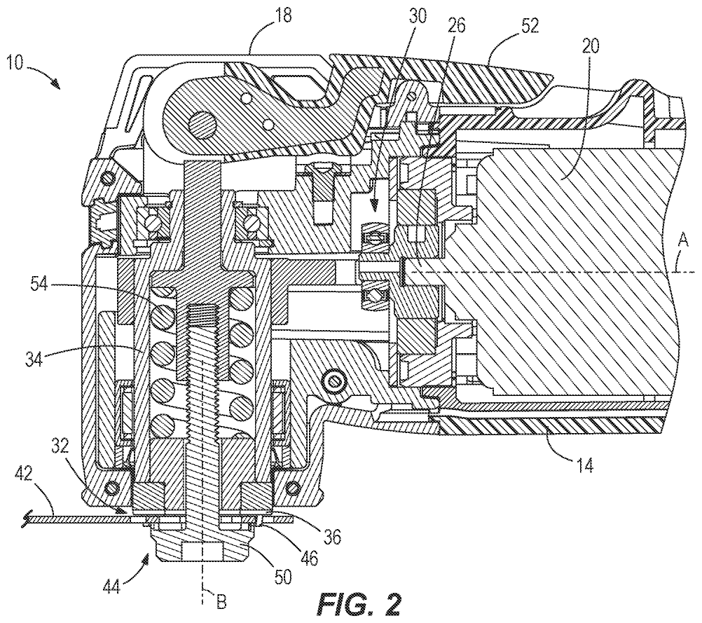

FIG. 1 illustrates a power tool 10 according to one implementation of the disclosure. The power tool 10 includes a main body 12 having a housing 14 defining a handle 16 and a head 18. The head 18 is driven by a motor 20 (FIG. 2) disposed within the housing 14. The handle 16 includes a grip portion 22 providing a surface suitable for grasping by an operator to operate the power tool 10. The housing 14 generally encloses the motor 20.

The motor 20 in the illustrated implementation is an electric motor driven by a power source such as a battery pack 24 (FIG. 1), but may be powered by other power sources such as an AC power cord in other implementations. In yet other implementations, the power tool 10 may be pneumatically powered or powered by any other suitable power source and the motor 20 may be a pneumatic motor or other suitable type of motor. The motor 20 includes a motor drive shaft 26 (FIG. 2) extending therefrom and driven for rotation about a motor axis A. The motor 20 may be a variable speed or multi-speed motor. In other implementations, other suitable motors may be employed.

The battery pack 24 (FIG. 1) is a removable and rechargeable battery pack. In the illustrated implementation, the battery pack 24 may include a 12-volt battery pack, a 14.4-volt battery pack, an 18-volt battery pack, or any other suitable voltage, and includes Lithium-ion battery cells (not shown). Additionally or alternatively, the battery cells may have chemistries other than Lithium-ion such as, for example, Nickel Cadmium, Nickel Metal-Hydride, or the like. In other implementations, other suitable batteries and battery packs may be employed, or the power tool 10 may be corded or pneumatically powered.

The main body 12 also includes a power actuator 28 (FIG. 1). The power actuator 28 is movably coupled with the housing 14 and is actuatable to power the motor 20, e.g., to electrically couple the battery pack 24 and the motor 20 to run the motor 20. The power actuator 28 may be a sliding actuator as shown, or in other implementations may include a trigger-style actuator, a button, a lever, a knob, etc.

The housing 14 also houses a drive mechanism 30 (FIG. 2) for converting rotary motion of the motor drive shaft 26 into rotary oscillating motion of an output mechanism 32. In other implementations, the drive mechanism 30 may convert rotary motion of the motor drive shaft 26 into rotary motion of the output mechanism 32, linear reciprocating motion of the output mechanism 32, or any other suitable motion conversion and/or transmission gear reduction. As shown in FIG. 2, the output mechanism 32 includes a spindle 34 having an accessory holder 36 disposed at a distal end thereof. As shown in FIG. 2, the spindle 34 terminates, at a free end, with the accessory holder 36. The accessory holder 36 is configured to receive an accessory, such as a blade 42, and a clamping mechanism 44 (FIG. 2) clamps the blade 42 to the accessory holder 36. The clamping mechanism 44 may include any suitable clamp for holding the blade 42 to the accessory holder 36, e.g., as are known for oscillating saws (as illustrated), as well as other saws, such as reciprocating saws, circular saws, band saws, etc. As illustrated, the accessory holder 36 includes a first locating feature 46, such as a protrusion or protrusions sized and shaped for receiving the blade 42. The clamping mechanism 44 includes a clamping flange 50 at a distal end thereof for clamping the blade 42 to the accessory holder 36 for oscillating motion with the spindle 34. A clamping actuator 52, such as a lever, is configured to apply and release a clamping force from a biasing member 54, such as a spring. The spindle 34 defines an oscillation axis B, substantially perpendicular to the motor axis A, about which the spindle 34 oscillates. In other implementations, other clamping actuators may be employed, such as a button, a knob, etc.

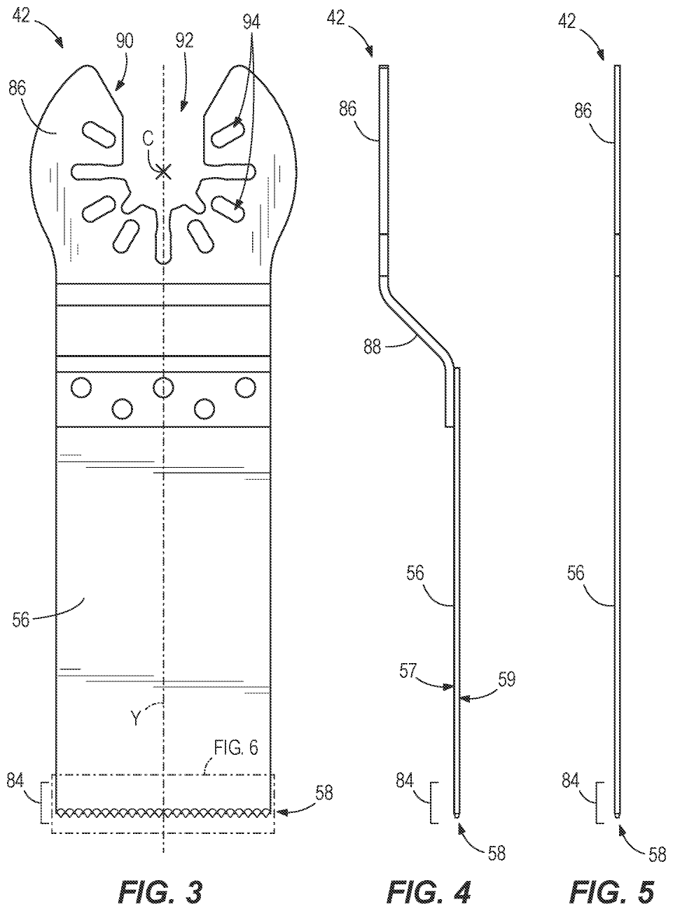

FIGS. 3-8 illustrate the blade 42 according to one implementation of the disclosure. The blade 42 includes a body 56 preferably formed from metal, which may include a metal, a metal alloy, a bi-metal, or any combination of metals, metal alloys, bi-metals, etc. For example, the metal may include hardened steel, spring steel, D6A, any type of steel, or any other suitable metal. The body 56 may be formed from other materials in other implementations. The body 56 defines a distal edge 58, which may be understood as the “thickness edge” disposed between two substantially planar blade body surfaces 57, 59 (see FIG. 4). A plurality of carbide tips 60 are disposed along the distal edge 58. In some implementations, the carbide tips 60 are aligned sequentially, one after another, in a linear fashion. The carbide tips 60 are attached to the body 56 by any suitable means, such as brazing, welding, or are otherwise fastened, adhered, or joined to the body 56. Each of the carbide tips 60 is provided as an individual unitary piece, discretely from the others, before being attached to the body 56, though the carbide tips 60 may each be further ground down, cut, and/or shaped before or after attachment to the body 56 (as will be described in greater detail below). Thus, each of the carbide tips 60 is discretely attached to the body 56. Each of the carbide tips 60 includes at least some carbide. For example, the carbide tips 60 may be formed entirely from carbide, may be coated or plated in carbide, or may include carbide therein in any other suitable fashion. Carbide is a compound including carbon and at least one other ingredient, such as one or more metals, one or more metal oxides, and/or one or more semi-metallic elements. For example, the carbide tips 60 may include H10F, titanium carbide, tungsten carbide, vanadium carbide, boron carbide, silicon carbide, etc., or any combination thereof. The carbide tips 60 may all include the same type of carbide, or some of the carbide tips 60 may be formed from different carbides than the others. The carbide tips 60 may each be formed from more than one type of carbide, in any combination, and may be formed from only carbide or from a combination of carbide and a non-carbide. The body 56 is formed from a different material than the carbide tips 60. The body 56 may have less carbide than the carbide tips 60. The body 56 may be formed from only non-carbide material. In some implementations, the body 56 is preferably non-carbide.

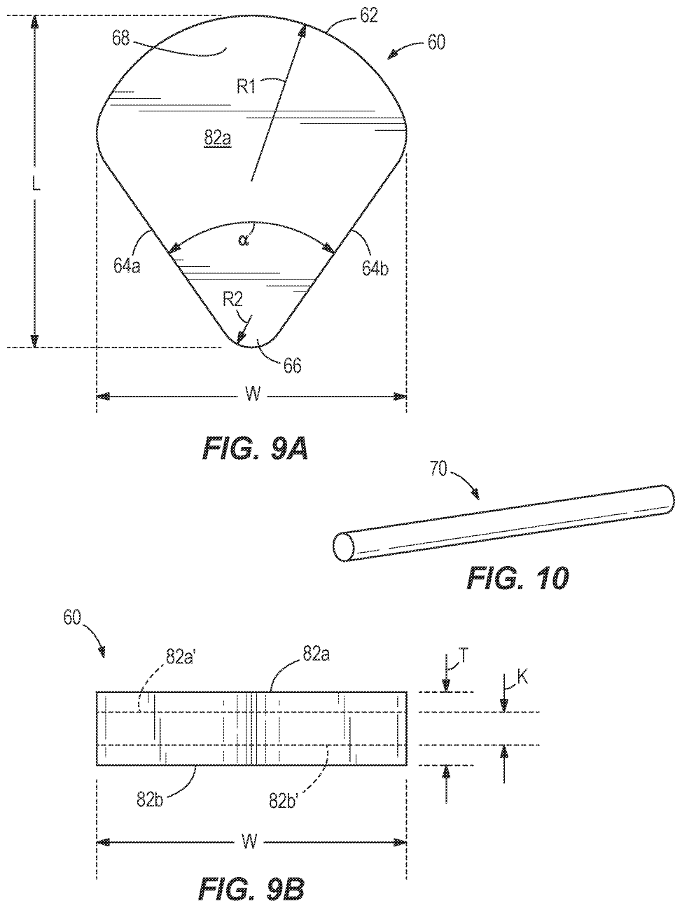

As best illustrated in the implementation of FIGS. 9A-9B, the carbide tips 60 may have a pie shape, which is defined as having a generally curved edge 62 and two generally straight edges 64a, 64b each extending from the generally curved edge 62 and meeting at a tip 66. The generally curved edge 62 may include any suitable curve, such as an arch, an arc, any other convex curve, a concave curve, or any combination of the above curves. For example, the curved edge 62 may have a radius of curvature R1 from 0.10 to 1.0 inches, more specifically from 0.5 to 0.8 inches, even more specifically of about 0.65 inches (+/−0.05 inches). In some implementations, the curved edge 62 is substantially straight such that the carbide tip 60 is a triangle. The two generally straight edges 64a, 64b need not be perfectly straight but are mostly straight, approximately straight, follow a straight path but may stray slightly from the straight path, or are straight. The two generally straight edges 64a, 64b may define an included angle α with respect to each other from 15 to 90 degrees, more specifically from 30 to 85 degrees, more specifically from 50 to 80 degrees, more specifically from 60 to 80 degrees, e.g., about 72 degrees (+/−3 degrees), or about 72 degrees or less. The two generally straight edges 64a, 64b may meet at the tip 66, which may be rounded (as illustrated) or pointed. The tip 66 may be rounded having a radius R2 of between about 0.300 inches and about 0.001 inches. More specifically, the radius R2 may be between about 0.100 inches and about 0.001 inches. Even more specifically, the radius R2 may be between about 0.005 inches and about 0.002 inches. As illustrated, the radius R2 is about 0.0039 inches. “About” means within a tolerance of +/−0.0039 inches for the radius R2.

Each of the carbide tips 60 includes the tip 66 and a root 68. The tip 66 protrudes from the body 56 of the blade 42 to from a cutting tooth, while the root 68 is rooted in the body 56 as will be described in greater detail below. The root 68 may have any suitable shape and is generally wider than the tip 66.

The shape illustrated herein is not to be regarded as limiting. The carbide tips 60 may have any suitable shape in other implementations, such as circular, triangular, polygonal, elliptical, oval, cylindrical, tubular, bar-shaped, irregular, etc., or any combination of the shapes described herein, or any other suitable shape. In the illustrated implementation, each of the carbide tips 60 has the same shape as the others; however, in other implementations, some of the carbide tips 60 may be shaped differently than others.

As illustrated in FIG. 9A, each of the carbide tips 60 has a length L. The length L is between about 0.200 inches and about 0.010 inches. More specifically, the length L is between about 0.100 inches and about 0.025 inches. Even more specifically, the length L is between about 0.060 inches and about 0.050 inches. In the illustrated implementation, the length L is about 0.054 inches.

The carbide tips 60 include opposite generally planar surfaces 82a, 82b. As illustrated in FIG. 9B, each of the carbide tips 60 has a width W and a thickness T before being attached to the body 56. The width W is between about 0.200 inches and about 0.020 inches. More specifically, the width W is between about 0.100 inches and about 0.030 inches. Even more specifically, the width W is between about 0.060 inches and about 0.040 inches. In the illustrated implementation, the width W is about 0.050 inches. The thickness T may be measured between the opposite generally planar surfaces 82a, 82b. The thickness T is between about 0.250 inches and about 0.020 inches. More specifically, the thickness T is between about 0.100 inches and about 0.030 inches. Even more specifically, the thickness T is between about 0.080 inches and about 0.060 inches. In the illustrated implementation, the thickness T is about 0.070 inches. “About” means within a tolerance of +/−0.002 inches for the length L, the width W, and the thickness T.

Each carbide tip 60 is a tooth of the blade 42. More specifically, each carbide tip 60 forms the entire tooth of the blade 42, i.e., is not attached to a tooth already formed in the body 56 of the blade 42. In other words, the body 56 of the blade 42 is untoothed before the carbide tips 60 are attached thereto, and the body 56 of the blade 42 does not define any cutting teeth after the carbide tips 60 are attached thereto. Rather, the entireties of the cutting teeth are provided by the carbide tips 60, which improves strength and durability compared with blades in which carbide is only provided at the tip of a tooth with the tooth being primarily formed in the body of the blade. In some implementations, the blade 42 has 16 teeth per inch (TPI) or less. In the illustrated implementation, the blade 42 has 16 TPI. In other implementations, the blade 42 may have between 2 and 25 TPI, or between 5 and 22 TPI, or between 7 and 20 TPI, or between 9 and 20 TPI, or between 11 and 20 TPI, or between 13 and 20 TPI, or between 14 and 18 TPI, or between 15 and 17 TPI, etc.

The size of each carbide tip 60 is determined according to the desired TPI. In the illustrated implementation, each of the carbide tips 60 has the same size as the others; however, in other implementations, some of the carbide tips 60 may be sized differently than others.

The carbide tips 60 may be net-shape, or near net-shape, meaning the carbide tips 60 are initially produced into the shape that is mounted to the body 56, or close to the shape that is mounted to the body 56. Manufacturing the carbide tips 60 in net-shape, or near net-shape, reduces the number of manufacturing steps required to produce the carbide tips 60 and saves costs. For example, the carbide tips may be pressed and sintered into the shape that is mounted to the body 56, or molded, formed, cast, etc., into the shape that is mounted to the body 56. Other suitable manufacturing techniques are also possible. In yet other implementations, the carbide tips 60 may be formed from a cylindrical blank 70 (FIG. 10). For example, the carbide tips 60 may be cut from the cylindrical blank 70 into circular discs (not shown) having the thickness T. The carbide tips 60 may then be machined (e.g., ground and/or cut, or any other suitable machining technique or combination thereof) into the pie shape illustrated herein, or machined into any other suitable shape, or not machined at all to retain the circular shape, and then attached to the body 56. In some implementations, the carbide tips 60 may be attached to the body 56 as the circular discs and then machined into the pie shape illustrated herein after attachment, or machined into any other suitable shape after attachment, or not machined at all. In other implementations, the carbide tips 60 may be formed in any suitable fashion, such as but not limited to machined from a bar, a blank, or any other type of stock, punched from a sheet, formed from any other suitable carbide blank, forged, sintered, cemented, molded, machined, cast, etc., or any other metallurgy technique.

As best illustrated in FIG. 7, the body 56 includes recesses 72 in the distal edge 58. A volume of each recess 72 is mostly filled or substantially filled by the carbide tip 60 (specifically the root 68) when received therein. Thus, the recesses 72 are not gullets provided between teeth for moving dust or debris during the cutting operation, as understood in the art of saw blade tooth forms. “Mostly filled” should be understood to mean more than half full, more than 75% full, more than 85% full, or more than 95% full. “Substantially filled” should be understood to mean entirely filled, or entirely filled but allowing for manufacturing tolerances, spaces provided to facilitate manufacture or use, manufacturing anomalies, e.g., air pockets, or having the appearance of being substantially filled as judged by one or ordinary skill in the art using the naked eye using ordinary reasonable judgement, etc. The carbide tip 60 received therein is attached primarily to the wall 74. Thus, each of the recesses 72 is configured to receive a respective one of the carbide tips 60 therein. Each of the recesses 72 may be provided as a discrete pocket from the other recesses 72, separated from an immediately adjacent one of the recesses 72 by a protrusion 76. Each protrusion 76 is disposed between each immediately adjacent pair of the recesses 72 (or similarly each immediately adjacent pair of carbide tips 60). The protrusion 76 is a part of the body 56 material that projects between immediately adjacent carbide tips 60 and helps support the immediately adjacent carbide tips 60. Each protrusion 76 has a distal end 78, which is a distal end of the body 56. The distal ends 78 collectively define the distal edge 58, at least in part. Each of the recesses 72 defines a wall 74 of the body 56 material having a start 75 at one distal end 78 and an end 77 at a directly adjacent distal end 78. Each wall 74 is therefore recessed from the distal ends 78. Each wall 74 has a shape, from the start 75 to the end 77, corresponding to a shape of the root 68 of the carbide tip 60 to be received therein. The distal edge 58 may be defined by the entire continuous “thickness edge” surface (e.g., the distal ends 78 and the walls 74 of the recesses 72). The cutting edge 58 is untoothed, and the distal ends 78 collectively when connected by an imaginary continuous line or curve 98 (as most appropriately corresponds to the arrangement and shape of the distal ends 78) are preferably substantially linear, arc-shaped, or circular, but may have any suitable arched or curved shape in other implementations. In some implementations, the imaginary continuous line or curve 98 is substantially linear (e.g., FIG. 7) or substantially convex (e.g., FIG. 13), not concave. In some implementations, each distal end 78 is substantially linear (e.g., FIG. 7) or substantially convex (e.g., FIG. 13) such as arc-shaped, and not concave. “Substantially” in this context should be understood to mean exactly or approximately, or how one of ordinary skill in the art would characterize the shape using the naked eye and ordinary reasonable judgement.

The carbide tips 60 may each be arranged along a normal line N (e.g., FIG. 13) to the imaginary continuous line or curve 98 such that the normal line N extends from root 68 to tip 66 of each carbide tip 60.

Each protrusion 76 may optionally diverge or increase in material width towards the distal end 78 to hold the carbide tips 60 in their respective recess 72, to inhibit the carbide tips 60 from detaching from the wall 74, to inhibit failure at the joint during use, etc. The protrusions 76 help root the carbide tips 60 into the body 56. As such, the protrusions 76 are not teeth, and the distal edge 58 is untoothed. In some implementations, the body 56 may include a strip of material (not shown) having the recesses 72 formed therein attached at the distal edge 58. In other implementations, the body 56 need not include the recesses 72 and the carbide tips 60 may be attached to the body 56 in any other suitable fashion, such as being attached to the distal edge 58 of the body 56, on one of the planar surfaces of the body 56, etc., or any other location on the body 56.

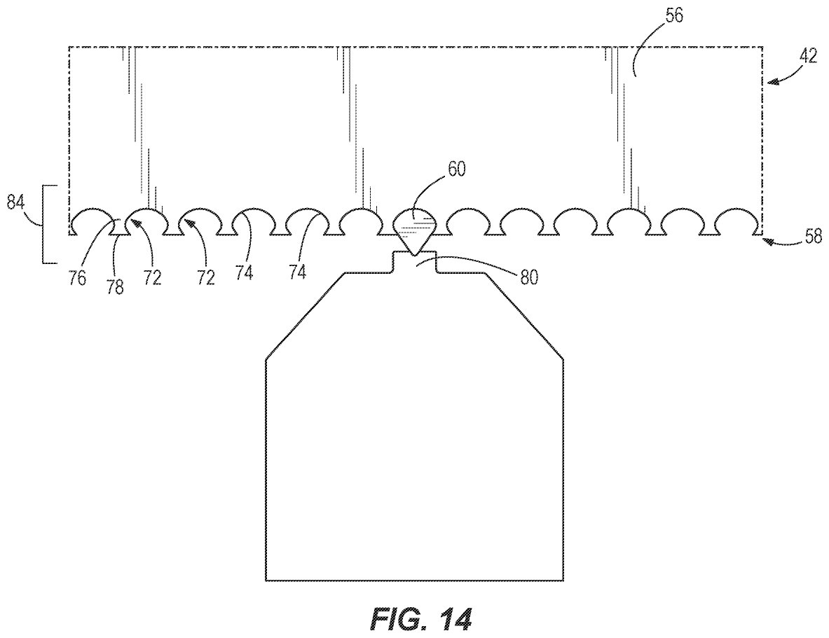

After the carbide tips 60 are received in the recesses 72, the carbide tips 60 may be attached to the body 56 in any suitable fashion, such as brazing (FIG. 8), welding (FIG. 14), or the like. As illustrated in FIG. 14, welding may be performed using an electrode 80, and in some implementations more than one of the electrode 80 may be employed to weld multiple carbide tips 60 simultaneously.

The carbide tips 60 may have a greater thickness T than the body 56, though they may have the same thickness as the body 56 in other implementations. After attachment, the carbide tips 60 may optionally be ground down to reduce the thickness T to create smaller kerf on the workpiece. The reduced thickness T of the carbide tips 60 is referred to herein as a kerf thickness K, which is also illustrated in FIG. 9B. One or both of the opposite generally planar surfaces 82a, 82b of each the carbide tips 60 may be ground down to achieve the kerf thickness K. Two ground-down surfaces 82a′, 82b′ are illustrated in FIG. 9B, though in some implementations only one of the surfaces 82a, 82b need be ground down. The kerf thickness K is between about 0.100 inches and about 0.020 inches. More specifically, the kerf thickness K is between about 0.08 inches and about 0.030 inches. Even more specifically, the kerf thickness K is between about 0.070 inches and about 0.060 inches. In the illustrated implementation, the kerf thickness K is about 0.063 inches. “About” means within a tolerance of +/−0.005 inches for the kerf thickness K.

In other implementations, the carbide tips 60 need not be ground down. In yet other implementations, the carbide tips 60 may be ground down before attachment to the body 56.

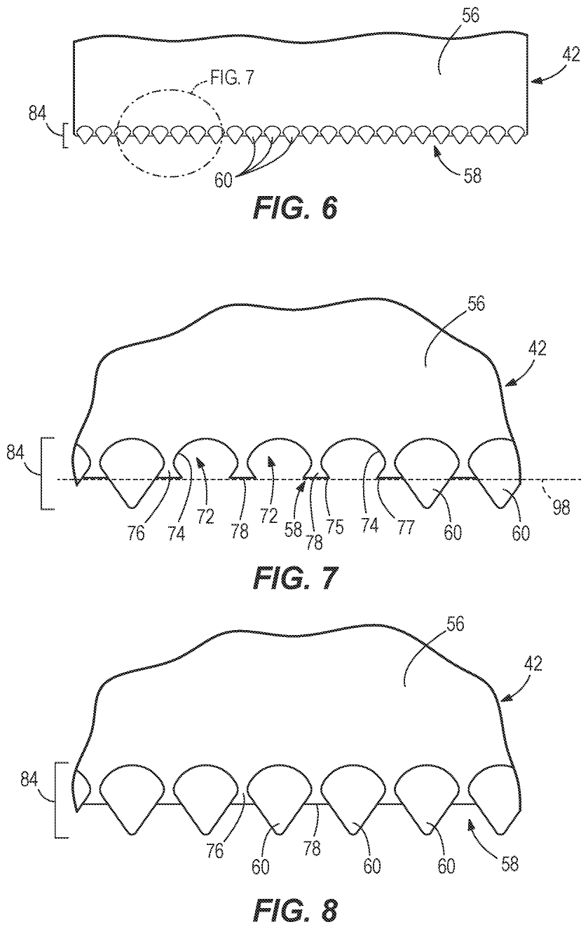

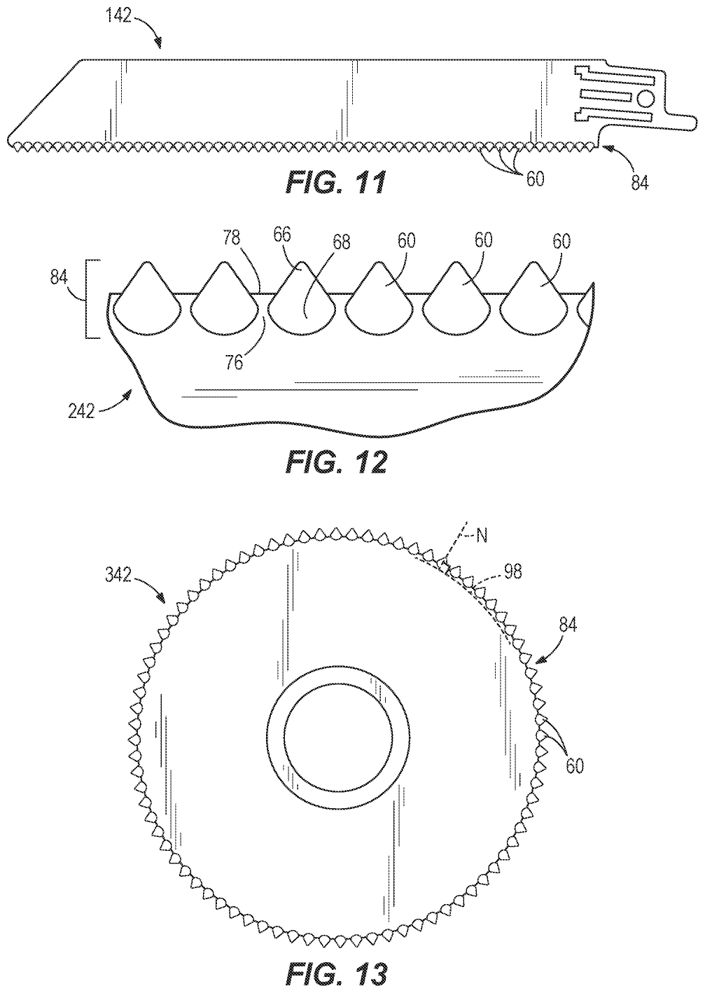

The carbide tips 60 are collectively referred to herein as a toothed portion 84. The toothed portion 84 is configured to perform a cutting operation on a workpiece (not shown). The toothed portion 84 (best illustrated in FIGS. 6-8) may be implemented on any type of blade and is not limited to the blade 42 illustrated in FIGS. 3-8 as an oscillating saw blade. For example, the blade 42 may be a reciprocating saw blade 142 (as shown in FIG. 11) including the toothed portion 84, a linear saw blade 242 (as shown in FIG. 12) including the toothed portion 84, a circular saw blade 342 (as shown in FIG. 13) including the toothed portion 84, etc., or any other type of blade including the toothed portion 84, including linear or curved blades. The linear saw blade 242 shown in FIG. 12 may include a band saw blade, a hack saw blade, any other type of powered blade, a hand tool blade, etc.

In the implementation of FIGS. 3-8, the blade 42 is embodied as an oscillating multi-tool blade and includes an attachment portion 86, the body 56 extending from the attachment portion 86. The blade 42 may be generally planar (as shown in the side view of FIG. 5) such that the attachment portion 86 and the body 56 generally extend in a single plane, though slight deviations from a plane may exist. In other implementations (as shown in the alternative side view of FIG. 4), the body 56 may be offset from the attachment portion 86 in a different plane, which may be generally parallel (as illustrated) thereto or may be transverse thereto at any desired angle. In such an implementation, a stepped portion 88 connects the attachment portion 86 to the body 56.

The attachment portion 86 includes a mounting aperture arrangement 90 including a central aperture 92 and a plurality of peripheral apertures 94 not in communication with the central aperture 92. In other implementations, the peripheral apertures 94 may be in communication with the central aperture 92. The attachment portion 86 is configured to engage with the clamping mechanism 44 to securely and releasably connect the blade 42 to the power tool 10. The central aperture 92 may be open, e.g., a slot, as shown in the illustrated implementation. In other implementations, the central aperture 92 may be a closed aperture. The central aperture 92 defines an anchor center C configured to intersect the oscillation axis B about which the blade 42 is configured to oscillate rotatingly when attached to and driven by the oscillating tool 10. The blade 42 defines a longitudinal axis Y generally perpendicular to the oscillation axis B, the longitudinal axis Y also intersecting the anchor center C and extending from the attachment portion 86 through the body 56. The longitudinal axis Y may also be defined as an axis of symmetry of the blade 42. In other implementations, the body 56 may be asymmetrical, or irregularly shaped, about the longitudinal axis Y. The toothed portion 84 may be employed on any type of oscillating multi-tool blade, or on any other type of cutting blade.

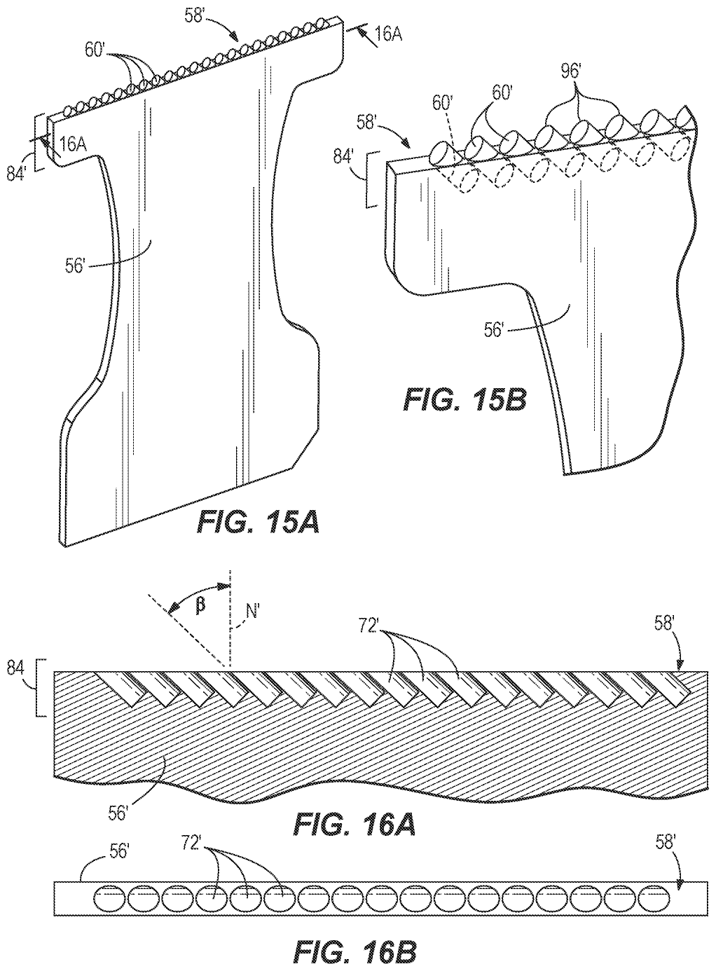

FIGS. 15A-16B illustrate another implementation of a blade body 56′ with another implementation of a toothed portion 84′. The toothed portion 84′ may be implemented on any blade body 56 on any type of blade 42 (as described above) in place of the toothed portion 84 described above. As such, reference is made to the blade 42, the distal edge 58, and the blade body 56 described above and need not be repeated. The same types of materials described above may also be applied to the toothed portion 84′ and body 56′ and need not be repeated. Differences are described below and a “′” is added to reference numerals for similar parts.

The toothed portion 84′ includes the distal edge 58′ of the body 56′ and carbide tips 60′ (FIGS. 15A-15B). The carbide tips 60′ are embodied as carbide cylinders (as illustrated in phantom in FIG. 15B). The carbide tips 60′ may be net-shape, near net-shape, cut from stock (e.g., see the cylindrical blank 70 in FIG. 10), or any other suitable manufacturing method to achieve an approximately cylindrical shape. The recesses 72′ are small holes or blind bores (e.g., cylindrical) machined (e.g., drilled) at an angle β (FIG. 16B) into the distal edge 58′ of the body 56′. The angle β may be any angle with respect to the distal edge 58′. For example, the angle β, which may be measured with respect to a normal N′ to the distal edge 58′, may be from 0 to 85 degrees to the normal N′, or from 10 to 75 degrees to the normal N′, or from 20 to 70 degrees to the normal N′, or from 30 to 60 degrees to the normal N′, or from 40 to 50 degrees to the normal N′, e.g., about 45 degrees (as illustrated) to the normal N′ (+/−2 degrees), etc. A different one of the carbide tips 60′ is disposed in each of the recesses 72′, and then attached by any suitable means (as described above). For example, the carbide tips 60′ may be brazed. Edges 96′ of the cylindrical shape of the carbide tips 60′ (e.g., circular-shaped or arc-shaped edges thereof) act as teeth without requiring grinding or postprocessing after attachment. The toothed portion 84′ may be employed on any of the types of blades described herein, as well as other types of blades.

In operation, the toothed portion 84, 84′ of the blade 42 performs a cutting operation on a workpiece, which may include a metal workpiece, such as a deck screw, sheet metal, etc. or other types of workpieces and materials. The toothed portion 84, 84′ with carbide tips 60, 60′ performs better and is more durable during use than other blades, e.g., other blades employing carbide only on a tip of each tooth, or a carbide rail having connected teeth (in which all teeth are connected as one monolithic piece), and may allow the user to push the blade 42 harder during use and still achieve a quality cut with less wear on the toothed portion 84, 84′. The rounded tips 66 may provide more durability and better performance than sharp carbide toothforms, which tend to chip and fracture during use.

Thus, the disclosure provides, among other things, a blade 42 having discrete carbide tips 60, 60′.

Although the disclosure has been described in detail with reference to certain preferred implementations, variations and modifications exist within the scope and spirit of one or more independent aspects of the disclosure as described.

What is claimed is:

1. A blade comprising:
a body having an untoothed distal edge, wherein a plurality of recesses are recessed from distal ends of the distal edge; and
a plurality of carbide tips attached to the body to form a toothed portion configured to perform a cutting operation, wherein each of the carbide tips is received in a respective one of the recesses, wherein each of the carbide tips at least mostly fills the respective one of the recesses.

2. The blade of claim 1, wherein each of the carbide tips substantially fills the respective one of the recesses.

3. The blade of claim 1, wherein the distal ends are disposed between the carbide tips, and wherein the distal ends are substantially linear, arc-shaped, or circular.

4. The blade of claim 1, wherein each of the plurality of carbide tips is provided discretely from the others.

5. The blade of claim 1, wherein each of the plurality of carbide tips forms a single tooth of the toothed portion.

6. The blade of claim 1, wherein the plurality of carbide tips are welded or brazed to the body.

7. The blade of claim 1, wherein at least one of the plurality of carbide tips is pie shaped.

8. The blade of claim 1, wherein at least one of the plurality of carbide tips is cylindrical.

9. The blade of claim 1, wherein each of the plurality of carbide tips includes a root disposed in the recess and a tip protruding from the body.

10. The blade of claim 9, wherein each of the recesses defines a wall of the body having a shape corresponding to a shape of the root of the carbide tip received therein.

11. A blade comprising:
a body; and
a plurality of discrete carbide tips attached to the body to form a toothed portion configured to perform a cutting operation;
wherein the body is untoothed.

12. The blade of claim 11, wherein the body defines a distal edge having a plurality of recesses recessed from distal ends such that each recess defines a wall that starts at one of the distal ends and ends at a directly adjacent one of the distal ends, wherein each of the walls has a shape corresponding to a shape of the carbide tip to be received therein, and wherein the distal edges are defined between immediately adjacent carbide tips.

13. The blade of claim 12, wherein the distal edges are substantially linear, arc-shaped, or circular.

14. The blade of claim 12, wherein each of the carbide tips substantially fills the respective one of the recesses.

15. The blade of claim 11, wherein each of the plurality of carbide tips is provided discretely from the others.

16. The blade of claim 11, wherein the plurality of carbide tips are welded or brazed to the body.

17. The blade of claim 11, wherein at least one of the plurality of carbide tips is pie shaped or cylindrical.

18. An oscillating multi-tool blade comprising:
an attachment portion configured to be driven in a rotational oscillating motion by an oscillating multi-tool;
a body extending from the attachment portion; and
a plurality of carbide tips attached to the body to form a toothed portion configured to perform a cutting operation, wherein each of the plurality of carbide tips is disposed discretely from the others.

19. The oscillating multi-tool blade of claim 18, wherein the body is untoothed.

20. The oscillating multi-tool blade of claim 18, wherein each of the carbide tips is disposed in a recess formed in a distal edge of the body.
